(19) United States
(12) Patent Application Publication
(10) Pub. No.: US 2025/0122080 A1
(43) Pub. Date: Apr. 17, 2025

(54) DOPED IRON PHOSPHATE, AND PREPARATION METHOD THEREFOR AND USE THEREOF

(71) Applicants: YICHANG BRUNP RECYCLING TECHNOLOGY CO., LTD., Yichang, Hubei (CN); YICHANG BRUNP YIHUA NEW MATERIAL CO., LTD, Yichang, Hubei (CN); GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN)

(72) Inventors: Ling Li, Foshan, Guangdong (CN); Changdong Li, Foshan, Guangdong (CN); Dingshan Ruan, Foshan, Guangdong (CN); Ruokui Chen, Foshan, Guangdong (CN); Zhenshuan Shi, Foshan, Guangdong (CN)

(21) Appl. No.: 18/682,130

(22) PCT Filed: Dec. 1, 2022
(86) PCT No.: PCT/CN2022/135884

§ 371 Date: Feb. 8, 2024

(30) Foreign Application Priority Data
Jan. 28, 2022 (CN) 202210108742.0

(51) Int. Cl. C01B 25/37; H01M 10/052

(52) U.S. Cl. CPC C01B 25/375; H01M 10/052; C01P 2002/74; C01P 2004/03; C01P 2006/40; C01P 2006/80

(57) ABSTRACT

The present application belongs to the technical field of battery materials. Disclosed are a doped iron (III) phosphate, a method for preparing same, and use thereof. The chemical formula of the doped iron (III) phosphate is (MnₓFe₁₋ₓ)@FePO₄·2H₂O, wherein 0<x<1. According to the present application, ferromanganese phosphate is used as a template agent for preparing the doped iron (III) phosphate. The doped iron (III) phosphate is regular in morphology and good in fluidity, facilitates washing and conveying, and can improve the electrochemical performance of the subsequently prepared LiFePO₄/C. When the doping amount of Mn is 11000 ppm, the specific discharge capacity of LiFePO₄/C at room temperature at 0.1 C rate can reach 165 mAh/g; the retention rate of the discharge capacity of 1000 cycles at 45° C. at 1 C rate can reach 97.4%; and at a low temperature of −15° C. the specific discharge capacity at 0.1 C rate is still 134 mAh/g.

### TECHNICAL FIELD

The present disclosure belongs to the technical field of battery materials, and in particular relates to doped iron phosphate, and a preparation method therefor and use thereof.

### BACKGROUND

Driven by the outbreak of new energy market and the rise of energy storage market, the shipment volume of lithium-ion batteries (LIBs) has surged. Lithium iron phosphate (LFP) has low ion conductivity and electron conductivity due to its own structural defects. In addition, LFP shows poor electrical performance at a low temperature. In response to these problems, researchers have proposed improvement methods mainly including: metal ion doping, coating a surface of LFP with a conductive layer, and reducing a size of a material.

In the prior art, a method for preparing LFP mainly includes: with ferric phosphate as a precursor and lithium carbonate as a lithium source, conducting grinding, spray-drying, sintering, and other operations. The ferric phosphate precursor is prepared by a precipitation method, that is, a precipitating agent or a complexing agent is added to chemically react with ions in a solution to produce a precipitate crystal. This method can lead to a product with uniform particle size distribution, but shows high requirements on a pH of a solution system (the pH needs to be adjusted by adding an alkali), which increases the difficulty of actual operation and makes it necessary to deal with alkali wastewater. Moreover, the electrochemical performance of the prepared LFP at low temperatures still needs to be improved.

### SUMMARY

The following is a summary of subject matters described in detail herein. The summary is not intended to limit the scope of protection of claims.

The present disclosure provides a doped iron phosphate, and a preparation method therefor and use thereof. Manganese-doped iron phosphate as precursor can improve the electrochemical performance of LiFePO₄/C prepared subsequently, and for the LiFePO₄/C, the specific discharge capacity at room temperature at 0.1 C is 165 mAh/g, and the discharge capacity retention rate after 1,000 cycles at 1 C exceeds 96%.

To achieve the above objective, the present disclosure adopts the following technical solutions:

A doped iron phosphate is provided, with a chemical formula of (MnₓFe₁₋ₓ)@FePO₄·2H₂O, where 0<x<1.

Preferably, a value of x may be in a range of 0.5≤x≤0.8.

Preferably, the doped iron phosphate may have a specific surface area (SSA) of 1.4 m²/g to 3.2 m²/g and Dv50 of 6.4 μm to 7.6 μm.

Preferably, Mn may be doped in an amount of 0.1% to 2%.

Further preferably, Mn may be doped in an amount of 0.4% to 1.1%.

A preparation method for the doped iron phosphate is provided, including the following steps:

(1) adding a phosphorus source to an iron-containing solution, mixing, adding ferromanganese phosphate, and heating to allow a reaction to obtain a mixed solution; and

(2) subjecting the mixed solution to solid-liquid separation (SLS) to obtain a solid, slurrying the solid to obtain a slurry, conducting SLS to the slurry to obtain a solid, and washing the solid to obtain manganese-doped iron phosphate dihydrate.

Preferably, in step (1), the iron-containing solution may be prepared by mixing an iron source and an acid liquor.

Further preferably, the iron source may be at least one of elemental iron, ferrous chloride, ferric chloride, ferrous sulfate, iron nitrate, ferrous acetate, waste ferric phosphate, ferrous phosphate, a ferrophosphorus residue, an iron phosphide residue, pyrite, or phosphosiderite.

More preferably, the iron source may be at least one of elemental iron, ferrous sulfate, waste ferric phosphate, and a ferrophosphorus residue.

More preferably, when the iron source is at least one of elemental iron, ferrous chloride, ferrous sulfate, and ferrous acetate, an oxidant needs to be added after the iron-containing solution and the phosphorus source are mixed, and the oxidant may be at least one of hydrogen peroxide, sodium peroxide, or ammonium persulfate (APS).

Further preferably, the oxidant may be hydrogen peroxide.

Preferably, in step (1), the phosphorus source may be at least one of phosphoric acid, phosphorous acid, sodium hypophosphite (SHP), waste ferric phosphate, ammonium dihydrogen phosphate (ADP), or ammonium phosphate.

Preferably, in step (1), a molar ratio of iron to phosphorus in the mixed solution may be 0.92 to 1.03, and further preferably, the iron/phosphorus ratio may be 0.97 to 1.

Preferably, in step (1), the ferromanganese phosphate may have a chemical formula of MnₓFe₁₋ₓPO₄, where 0<x<1.

Further preferably, a value of x may be in a range of 0.5<x<0.8.

Preferably, in step (1), the reaction may be conducted at 70° C. to 100° C.; and further preferably, the reaction may be conducted at 80° C. to 95° C.

Preferably, the reaction may be conducted for 2 h to 10 h; and further preferably, the reaction may be conducted for 4 h to 8 h.

Preferably, in step (2), the slurrying may be conducted with a liquid-to-solid ratio of 1:(2-3) g/L.

Preferably, in step (2), a filtrate obtained after the washing may have electric conductivity less than or equal to 500 μs/cm; and further preferably, the filtrate obtained after the washing may have electric conductivity less than or equal to 200 μs/cm.

Preferably, step (2) may further include subjecting the manganese-doped iron phosphate dihydrate to calcination to obtain anhydrous iron phosphate.

Further preferably, the calcination may be conducted at 300° C. to 650° C.; and more preferably, the calcination may be conducted at 450° C. to 550° C.

Principle: A solubility product equilibrium constant of ferric phosphate at room temperature is as small as 1.3*10⁻²², and it is relatively difficult to spontaneously form a ferric phosphate precipitate in a homogeneous system. Therefore, an alkali or ammonia is generally added to increase a pH of a solution, so as to promote reaction. In the present disclosure, no alkali or ammonia needs to be added to adjust the pH of the solution. By adding an additive of ferromanganese phosphate, on one hand, the precipitation of ferric phosphate is induced on ferromanganese phosphate lattices; and on the other hand, the reaction is accelerated because an energy barrier for the generation of a new precipitate is reduced due to a new interface formed after the addition of the solid (ferromanganese phosphate) to the solution, thereby producing manganese-doped iron phosphate dihydrate analogous to a core-shell structure.

A preparation method for carbon-coated manganese-doped LFP is provided, including the following steps:
subjecting the manganese-doped iron phosphate dihydrate to a first calcination, adding a lithium source and a carbon source and mixing, and subjecting a resulting mixture to spray granulation and a second calcination to obtain the carbon-coated manganese-doped LFP.

Preferably, the lithium source may be at least one of lithium carbonate, lithium hydroxide, and lithium dihydrogen phosphate; and further preferably, the lithium source may be lithium carbonate.

Preferably, the carbon source may be at least one of glucose, sucrose, soluble starch, carbon black, and graphene; and further preferably, the carbon source may be sucrose.

Preferably, the first calcination may be conducted at 650° C. to 800° C. for 6 h to 16 h.

Further preferably, the second calcination may be conducted at 650° C. to 700° C. for 6 h to 10 h.

Preferably, the second calcination may be conducted in an inert atmosphere, and preferably a nitrogen atmosphere.

The present disclosure also provides use of the doped iron phosphate described above in the preparation of a lithium battery cathode material.

The present disclosure also provides a battery, including the carbon-coated manganese-doped LFP prepared by the preparation method described above.

Compared with the prior art, the present disclosure has the following beneficial effects.

(1) In the present disclosure, ferromanganese phosphate is used as a template agent to prepare the doped iron phosphate. The doped iron phosphate has regular morphology and prominent fluidity, which is beneficial to washing and transportation and improves the electrochemical performance of LiFePO₄/C prepared therewith subsequently. When a doping amount of Mn is 11,000 ppm, for LiFePO₄/C, the specific discharge capacity at room temperature and 0.1 C can reach 165 mAh/g; the discharge capacity retention rate after 1,000 cycles at 1 C and 45° C. can reach 97.4%; and the specific discharge capacity at −15° C. and 0.1 C still can reach 134 mAh/g.

(2) In the present disclosure, after the phosphorus source is added to the iron-containing solution, ferromanganese phosphate is added as a template agent, which induces the precipitation of ferric phosphate on ferromanganese phosphate lattices, and accelerates the reaction, because an energy barrier for the generation of a new precipitate is reduced due to a new interface formed after the addition of the solid (ferromanganese phosphate) to the solution, thereby producing a precursor analogous to a core-shell structure. The above reaction does not require an alkali liquor or ammonia to adjust a pH of the solution, and thus there is no need to handle alkali wastewater, which is environmentally friendly and makes it easy to achieve mass production.

Other aspects can be apparent upon reading and understanding the drawings and detailed description.

### BRIEF DESCRIPTION OF THE DRAWINGS

The drawings are used to provide a further understanding of the technical solutions herein, constitute a part of the description, and explain the technical solutions in conjunction with examples of the present disclosure, without limitation thereto.

FIG. 1 is a scanning electron microscopy (SEM) image of manganese-doped iron phosphate dihydrate prepared in Example 1 of the present disclosure;

FIG. 2 is an SEM image of carbon-coated manganese-doped LFP prepared in Example 1 of the present disclosure;

FIG. 3 is an X-ray diffraction (XRD) pattern of manganese-doped iron phosphate dihydrate prepared in Example 1 of the present disclosure; and

FIG. 4 is an XRD pattern of carbon-coated manganese-doped LFP prepared in Example 1 of the present disclosure.

### DETAILED DESCRIPTION

The concepts and technical effects of the present disclosure are clearly and completely described below in conjunction with examples, so as to allow the objectives, features and effects of the present disclosure to be fully understood. Apparently, the described examples are merely some rather than all of the examples of the present disclosure. All other examples obtained by those skilled in the art based on the examples of the present disclosure without creative efforts should fall within the protection scope of the present disclosure.

### Example 1

A preparation method for manganese-doped iron phosphate was provided in this example, specifically including the following steps:
(1) preparation of a mixed metal solution: 100 L of sulfuric acid with a concentration of 1.2 mol/L was added to a tank with a stirrer, then 23.54 kg of an iron phosphide waste was added, and a resulting mixture was stirred for dissolution to obtain the mixed metal solution containing iron and phosphorus;
(2) the prepared mixed metal solution containing iron and phosphorus was poured into a reaction vessel, stirring was started at a stirring speed of 450 rpm, and 500 g of ferromanganese phosphate (Mn_{0.8}Fe_{0.2}PO₄) was added; and a resulting mixture was heated to 90° C. and kept at 90° C. for 4 h, then the heating was stopped, and after the reaction was completed, a reaction slurry was subjected to SLS with a centrifuge to obtain a solid filter cake; and
(3) the filter cake obtained in step (2) was added to a slurrying tank, deionized water was added, and a resulting mixture was thoroughly stirred and filtered to obtain a filter cake; and the filter cake was repeatedly washed with deionized water until washing water had electric conductivity less than 500 μs/cm to obtain a manganese-doped iron phosphate dihydrate solid, (Mn_{0.8}Fe_{0.2})@FePO₄·2H₂O.

A preparation method for carbon-coated manganese-doped LFP was provided in this example, specifically including the following steps:
(1) the iron phosphate dihydrate solid obtained after the washing was spread in an oven at 100° C. and dried, and then subjected to a first calcination for 3 h at 550° C. in an air atmosphere to obtain anhydrous iron phosphate; and
(2) 15.08 kg of the anhydrous iron phosphate and 3.77 kg of lithium carbonate were weighed and mixed with suitable sucrose, a resulting mixture was subjected to sand milling and spray drying to obtain a powder, and the powder was subjected to a second calcination for 6 h at 720° C. under a nitrogen atmosphere in a box-type furnace to obtain the carbon-coated manganese-doped LFP.

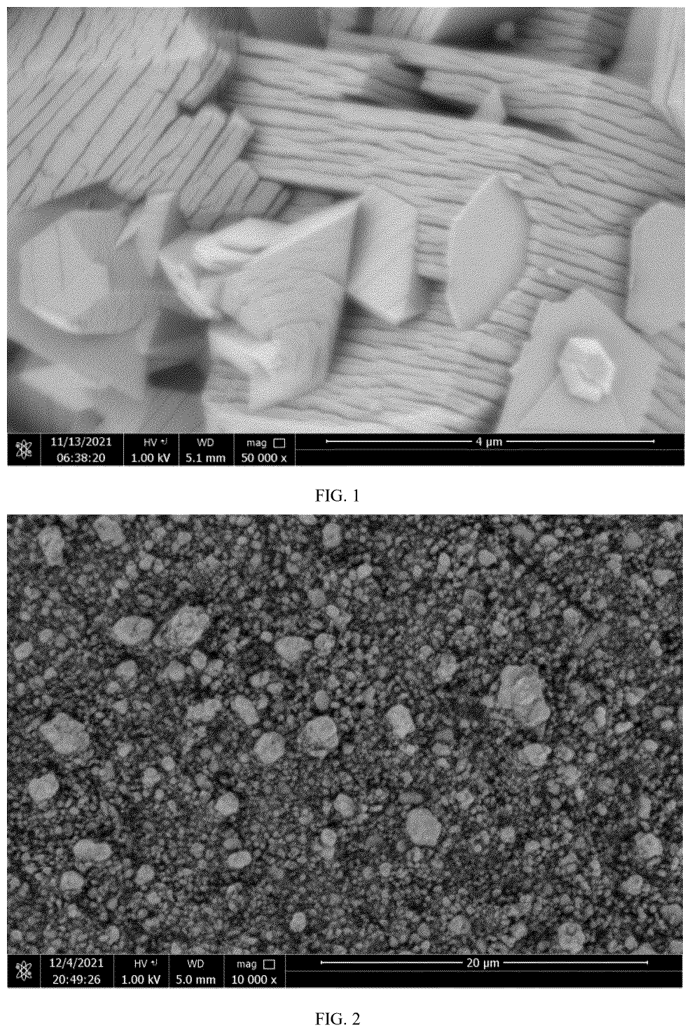

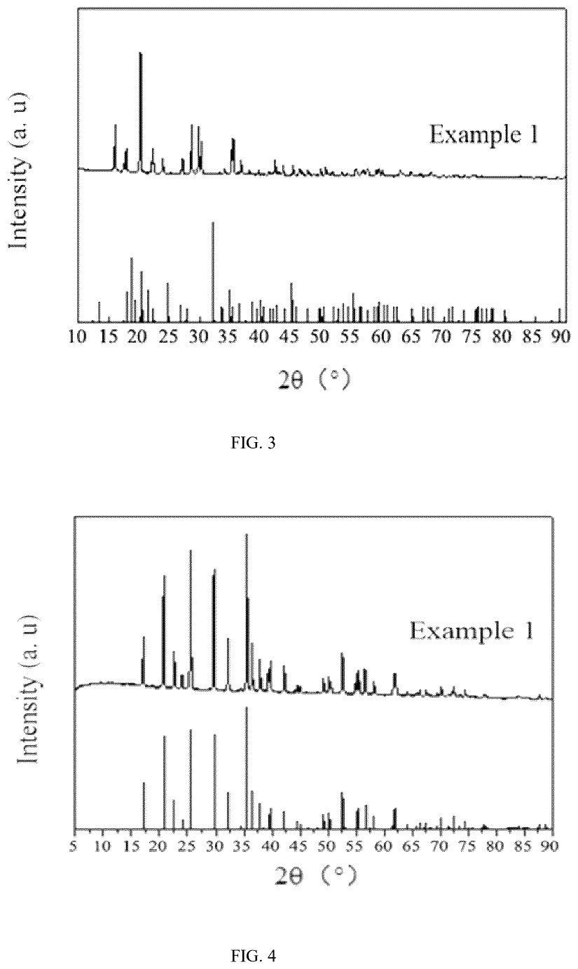

FIG. 1 and FIG. 3 were respectively an SEM image and an XRD pattern of the iron phosphate dihydrate prepared in Example 1; and FIG. 2 and FIG. 4 were respectively an SEM image and an XRD pattern of the carbon-coated manganese-doped LFP prepared in Example 1. It can be seen from FIG. 1 that the prepared iron phosphate dihydrate was composed of irregular blocky particles; and it can be seen from the XRD pattern of the iron phosphate dihydrate prepared in Example 1 in FIG. 3 that the product obtained in Example 1 is ferric phosphate, and the manganese doping does not affect a structure of ferric phosphate.

FIG. 2 was an SEM image of the LFP prepared in Example 1, which was composed of irregular small and large particles. FIG. 4 was an XRD pattern of the LFP prepared in Example 1, and it can be seen from the figure that the product obtained in this example is pure-phase olivine-type LFP.

### Example 2

A preparation method for manganese-doped iron phosphate was provided in this example, specifically including the following steps:
(1) preparation of a mixed metal solution: 22.36 kg of ferrous sulfate was weighed and added to a stirring tank, 90 L of deionized water was added, and a resulting mixture was stirred for dissolution to obtain an iron-containing metal solution; and 9.27 kg of phosphoric acid and 4.5 kg of hydrogen peroxide were added, and a resulting mixture was thoroughly stirred to obtain the mixed metal solution containing iron and phosphorus;
(2) the prepared mixed metal solution containing iron and phosphorus was poured into a reaction vessel, stirring was started at a stirring speed of 450 rpm, and 325 g of ferromanganese phosphate (Mn_{0.6}Fe_{0.4}PO₄) was added; and a resulting mixture was heated to 90° C. and kept at 90° C. for 4 h, then the heating was stopped, and after the reaction was completed, a reaction slurry was subjected to SLS with a centrifuge to obtain a solid filter cake; and
(3) the filter cake obtained in step (2) was added to a slurrying tank, deionized water was added, and a resulting mixture was thoroughly stirred and filtered to obtain a filter cake; and the filter cake was repeatedly washed with deionized water until washing water had electric conductivity less than 500 μs/cm to obtain a manganese-doped iron phosphate dihydrate solid, (Mn_{0.6}Fe_{0.4})@FePO₄·2H₂O.

A preparation method for carbon-coated manganese-doped LFP was provided in this example, specifically including the following steps:
(1) the iron phosphate dihydrate solid obtained after the washing was spread in an oven at 100° C. and dried, and then subjected to a first calcination for 3 h at 550° C. in an air atmosphere to obtain anhydrous iron phosphate; and
(2) 15.08 kg of the anhydrous iron phosphate and 3.77 kg of lithium carbonate were weighed and mixed with suitable sucrose, a resulting mixture was subjected to sand milling and spray drying to obtain a powder, and the powder was subjected to a second calcination for 6 h at 720° C. under a nitrogen atmosphere in a box-type furnace to obtain the manganese-doped LFP/carbon composite material.

### Example 3

A preparation method for manganese-doped iron phosphate was provided in this example, specifically including the following steps:
(1) preparation of a mixed metal solution: 4.4 kg of a waste iron powder was added to a storage tank with 8.5 kg of phosphoric acid, and a resulting mixture was stirred for dissolution to obtain the mixed metal solution containing iron and phosphorus;
(2) the prepared mixed metal solution containing iron and phosphorus was poured into a reaction vessel, stirring was started at a stirring speed of 450 rpm, and 358 g of ferromanganese phosphate (Mn_{0.5}Fe_{0.5}PO₄) was added; and a resulting mixture was heated to 90° C. and kept at 90° C. for 4 h, then the heating was stopped, and after the reaction was completed, a reaction slurry was subjected to SLS with a centrifuge to obtain a solid filter cake; and
(3) the filter cake obtained in step (2) was added to a slurrying tank, deionized water was added, and a resulting mixture was thoroughly stirred and filtered to obtain a filter cake; and the filter cake was repeatedly washed with deionized water until washing water had electric conductivity less than 500 μs/cm to obtain a manganese-doped iron phosphate dihydrate solid, (Mn_{0.5}Fe_{0.5})@FePO₄·2H₂O.

A preparation method for carbon-coated manganese-doped LFP was provided in this example, specifically including the following steps:
(1) the iron phosphate dihydrate solid obtained after the washing was spread in an oven at 100° C. and dried, and then subjected to a first calcination for 3 h at 550° C. in an air atmosphere to obtain anhydrous iron phosphate; and
(2) 15.08 kg of the anhydrous iron phosphate and 3.77 kg of lithium carbonate were weighed and mixed with suitable sucrose, a resulting mixture was subjected to sand milling and spray drying to obtain a powder, and the powder was subjected to a second calcination for 6 h at 720° C. under a nitrogen atmosphere in a box-type furnace to obtain the manganese-doped LFP/carbon composite material.

### Comparative Example 1 (Without Manganese Doping)

A preparation method for ferric phosphate was provided in this comparative example, specifically including the following steps:
(1) preparation of a mixed metal solution: 100 L of sulfuric acid with a concentration of 1.2 mol/L was added to a tank with a stirrer, then 23.54 kg of an iron phosphide waste was added, and a resulting mixture was stirred for dissolution to obtain the mixed metal solution containing iron and phosphorus;
(2) the prepared mixed metal solution containing iron and phosphorus was poured into a reaction vessel, stirring was started at a stirring speed of 450 rpm, and a resulting mixture was heated to 90° C. and kept at 90° C. for 4 h; and then the heating was stopped, and after the reaction was completed, a reaction slurry was subjected to SLS with a centrifuge to obtain a solid filter cake, where during the reaction, a sodium hydroxide solution was continuously added to control a pH of the system at 2.0; and
(3) the filter cake obtained in step (2) was added to a slurrying tank, deionized water was added, and a resulting mixture was thoroughly stirred and filtered to obtain a filter cake; and the filter cake was repeatedly washed with deionized water until washing water had electric conductivity less than 500 μs/cm to obtain an iron phosphate dihydrate solid, FePO₄·2H₂O.

A preparation method for carbon-coated LFP was provided in this comparative example, specifically including the following steps:
(1) the iron phosphate dihydrate solid obtained after the washing was spread in an oven at 100° C. and dried, and then subjected to calcination for 3 h at 550° C. in an air atmosphere to obtain anhydrous iron phosphate; and
(2) 15.08 kg of the anhydrous iron phosphate and 3.77 kg of lithium carbonate were weighed and mixed with suitable sucrose, a resulting mixture was subjected to sand milling and spray drying to obtain a powder, and the powder was subjected to calcination for 6 h at 720° C. under a nitrogen atmosphere in a box-type furnace to obtain the carbon-coated LFP.

### Comparative Example 2 (a Precursor Was Prepared First and Then Manganese Was Doped.)

A preparation method for ferric phosphate was provided in this comparative example, specifically including the following steps:
(1) preparation of a mixed metal solution: 100 L of sulfuric acid with a concentration of 1.2 mol/L was added to a tank with a stirrer, then 23.54 kg of an iron phosphide waste was added, and a resulting mixture was stirred for dissolution to obtain the mixed metal solution containing iron and phosphorus;
(2) the prepared mixed metal solution containing iron and phosphorus was poured into a reaction vessel, stirring was started at a stirring speed of 450 rpm, and a sodium hydroxide solution (20 kg of sodium hydroxide was added to a stirring tank filled with deionized water, and a resulting mixture was stirred for dissolution to obtain the sodium hydroxide solution) was added to control a pH of the system at 2.0; and a resulting mixture was heated to 90° C. and kept at 90° C. for 4 h, then the heating was stopped, and after the reaction was completed, a reaction slurry was subjected to SLS with a centrifuge to obtain a solid filter cake; and
(3) the filter cake obtained in step (2) was added to a slurrying tank, deionized water was added, and a resulting mixture was thoroughly stirred and filtered to obtain a filter cake; and the filter cake was repeatedly washed with deionized water until washing water had electric conductivity less than 500 μs/cm to obtain an iron phosphate dihydrate solid, FePO₄·2H₂O.

A preparation method for carbon-coated manganese-doped LFP was provided in this comparative example, specifically including the following steps:
(1) the iron phosphate dihydrate solid obtained after the washing was spread in an oven at 100° C. and dried, and then subjected to calcination for 3 h at 550° C. in an air atmosphere to obtain anhydrous iron phosphate; and
(2) 15.08 kg of the anhydrous iron phosphate, 3.77 kg of lithium carbonate, and 255 g of nano-manganese dioxide MnO₂ were weighed and mixed with sucrose, a resulting mixture was subjected to sand milling and spray drying to obtain a powder, and the powder was subjected to calcination for 6 h at 720° C. under a nitrogen atmosphere in a box-type furnace to obtain the carbon-coated manganese-doped LFP.

### Analysis of Examples 1 to 3 and Comparative Examples 1 and 2

Table 1 showed physical and chemical performance data of the iron phosphate dihydrate products prepared in Examples 1, 2, and 3 and Comparative Examples 1 and 2, and the specific data were obtained by a test of an inductively coupled plasma atomic emission spectroscopy (ICP-AES) machine. It can be seen from Table 1 that the prepared iron phosphate dihydrate products had a large particle size and a small SSA.

TABLE 1
Physical and chemical performance of iron phosphate
dihydrate products

| | Example | Example | Example | Comparative | Comparative |
|---|---|---|---|---|---|
| | 1 | 2 | 3 | Example 1 | Example 2 |
| Fe/% | 28.89 | 28.87 | 29 | 29.21 | 29.05 |
| P/% | 16.47 | 16.3 | 16.46 | 16.51 | 16.41 |
| Fe/P | 0.973 | 0.974 | 0.977 | 0.981 | 0.981 |
| Mn/% | 1.024 | 0.4985 | 0.5037 | 0 | 0 |
| Dv50 | 7.43 | 6.5 | 6.9 | 3.85 | 3.68 |
| BET | 1.45 | 3 | 2.6 | 51.8 | 49.7 |

It can be seen from Table 1 that the iron phosphate dihydrate prepared in each of Examples 1 to 3 of the present disclosure had a large particle size, a small SSA, and a regular shape, which leads to prominent fluidity, easy washing, and excellent subsequent processability; and the product in each of Comparative Examples 1 and 2 had a small particle size and a large BET, was difficult to wash, and showed poor fluidity, high viscosity, and relatively poor subsequent processability. It can be seen from Table 2 that, with the same iron source and phosphorus source (Example 1 and Comparative Example 1/Comparative Example 2), no alkali or ammonia needed to be added to adjust a pH in the present disclosure, resulting in lower cost.

TABLE 2
Cost data of the preparation of iron phosphate dihydrate products

| | Example | Example | Example | Comparative | Comparative |
|---|---|---|---|---|---|
| | 1 | 2 | 3 | Example 1 | Example 2 |
| Alkali | 0 | 0 | 0 | 0.3 | 0.3 |
| consumption/ | | | | | |
| kg | | | | | |
| Cost CNY/kg | 10.67 | 25.4 | 105.4 | 12.5 | 12.5 |

### Test Example

The iron phosphate dihydrate prepared in Examples 1 to 3 and the iron phosphate dihydrate prepared in Comparative Examples 1 and 2 were each prepared into LFP by a conventional method under the same conditions, and the electrical performance was determined for the prepared LFP. Results were shown in Table 3 below.

TABLE 3

| Electro- | | | | | |
|---|---|---|---|---|---|
| chemical | Example | Example | Example | Comparative | Comparative |
| performance | 1 | 2 | 3 | Example 1 | Example 2 |
| Initial | 163.6 | 162.5 | 161.9 | 153.7 | 155.4 |
| specific | | | | | |
| discharge | | | | | |
| capacity | | | | | |
| (mAh/g) | | | | | |
| Initial | 98.8 | 97.6 | 97.2 | 93.6 | 95.3 |
| charge/ | | | | | |
| discharge | | | | | |
| efficiency | | | | | |
| (%) | | | | | |
| Discharge | 96.5 | 95.0 | 95.2 | 89.6 | 93.7 |
| capacity | | | | | |
| retention | | | | | |
| rate after | | | | | |
| 1,000 cycles | | | | | |
| at 1 C (%) | | | | | |
| Specific | 134.1 | 127.8 | 127.7 | 92.2 | 115.6 |
| discharge | | | | | |
| capacity at | | | | | |
| −15° C. and | | | | | |
| 0.1 C | | | | | |
| (mAh/g) | | | | | |

The electrochemical performance of the LFP powder prepared from the iron phosphate dihydrate synthesized in each of Examples 1 to 3 of the present disclosure was significantly better than the electrochemical performance of the LFP powder without manganese doping (Comparative Example 1), and was also better than the electrochemical performance of the LFP powder in which a precursor was prepared first and then manganese was doped. In particular, the specific discharge capacity and discharge capacity retention rate at a low temperature were much higher than those of Comparative Examples 1 and 2.

The examples of present disclosure are described in detail with reference to the accompanying drawings, but the present disclosure is not limited to the above examples. Within the scope of knowledge possessed by those of ordinary skill in the technical field, various changes can also be made without departing from the purpose of the present disclosure. In addition, the examples and features in the examples in the present disclosure may be combined with each other in a non-conflicting situation.

1. Doped iron phosphate, wherein the doped iron phosphate has a chemical formula of (MnₓFe₁₋ₓ)@FePO₄·2H₂O, wherein 0<x<1.

2. The doped iron phosphate according to claim 1, wherein a value of x is in a range of 0.5≤x≤0.8.

3. The doped iron phosphate according to claim 1, wherein the doped iron phosphate has a specific surface area of 1.4 m²/g to 3.2 m²/g and Dv50 of 6.4 μm to 7.6 μm.

4. The doped iron phosphate according to claim 1, wherein Mn is doped in an amount of 0.1% to 2%.

5. A preparation method for the doped iron phosphate according to claim 1, comprising the following steps:
(1) adding a phosphorus source to an iron-containing solution, mixing, adding ferromanganese phosphate, and heating to allow a reaction to obtain a mixed solution; and
(2) subjecting the mixed solution to solid-liquid separation (SLS) to obtain a solid, slurrying the solid to obtain a slurry, subjecting the slurry to SLS to obtain a solid, and washing the solid to obtain manganese-doped iron phosphate dihydrate.

6. The preparation method according to claim 5, wherein in step (1), the iron-containing solution is prepared by mixing an iron source with an acid liquor; the iron source is at least one of elemental iron, ferrous chloride, ferric chloride, ferrous sulfate, iron nitrate, ferrous acetate, waste ferric phosphate, ferrous phosphate, a ferrophosphorus residue, an iron phosphide residue, pyrite, or phosphosiderite; and when the iron source is at least one of elemental iron, ferrous chloride, ferrous sulfate, or ferrous acetate, an oxidant needs to be added after the iron-containing solution and the phosphorus source are mixed, and the oxidant is at least one of hydrogen peroxide, sodium peroxide, or ammonium persulfate.

7. The preparation method according to claim 5, wherein in step (1), the phosphorus source is at least one of phosphoric acid, phosphorous acid, sodium hypophosphite, waste ferric phosphate, ammonium dihydrogen phosphate, or ammonium phosphate.

8. The preparation method according to claim 5, wherein in step (1), the ferromanganese phosphate has a chemical formula of MnₓFe₁₋ₓPO₄, wherein 0<x<1.

9. The preparation method according to claim 5, wherein in step (1), a ratio of iron to phosphorus in the mixed solution is 0.92 to 1.03.

10. The preparation method according to claim 5, wherein in step (2), the slurrying is conducted with a liquid-to-solid ratio of 1:(2-3) L/g, and a filtrate obtained after the washing has an electric conductivity less than or equal to 500 μs/cm.

11. A preparation method for carbon-coated manganese-doped lithium iron phosphate, comprising the following steps:
subjecting the doped iron phosphate according to claim 1 to a first calcination, adding a lithium source and a carbon source, and mixing, subjecting a resulting mixture to spray granulation and a second calcination to obtain the carbon-coated manganese-doped lithium iron phosphate.

12. Use of the doped iron phosphate according to claim 1 in the preparation of a lithium battery cathode material.

13. A battery, comprising the carbon-coated manganese-doped lithium iron phosphate prepared by the preparation method according to claim 11.

14. A preparation method for the doped iron phosphate according to claim 2, comprising the following steps:
(1) adding a phosphorus source to an iron-containing solution, mixing, adding ferromanganese phosphate, and heating to allow a reaction to obtain a mixed solution; and
(2) subjecting the mixed solution to solid-liquid separation (SLS) to obtain a solid, slurrying the solid to obtain a slurry, subjecting the slurry to SLS to obtain a solid, and washing the solid to obtain manganese-doped iron phosphate dihydratee.

15. A preparation method for the doped iron phosphate according to claim 3, comprising the following steps:
(1) adding a phosphorus source to an iron-containing solution, mixing, adding ferromanganese phosphate, and heating to allow a reaction to obtain a mixed solution; and
(2) subjecting the mixed solution to solid-liquid separation (SLS) to obtain a solid, slurrying the solid to obtain a slurry, subjecting the slurry to SLS to obtain a solid, and washing the solid to obtain manganese-doped iron phosphate dihydrateee.

16. A preparation method for the doped iron phosphate according to claim 4, comprising the following steps:
(1) adding a phosphorus source to an iron-containing solution, mixing, adding ferromanganese phosphate, and heating to allow a reaction to obtain a mixed solution; and
(2) subjecting the mixed solution to solid-liquid separation (SLS) to obtain a solid, slurrying the solid to obtain a slurry, subjecting the slurry to SLS to obtain a solid, and washing the solid to obtain manganese-doped iron phosphate dihydrateee.

17. A preparation method for carbon-coated manganese-doped lithium iron phosphate, comprising the following steps:
subjecting the doped iron phosphate according to claim 2 to a first calcination, adding a lithium source and a carbon source, and mixing, subjecting a resulting mixture to spray granulation and a second calcination to obtain the carbon-coated manganese-doped lithium iron phosphate.

18. A preparation method for carbon-coated manganese-doped lithium iron phosphate, comprising the following steps:
subjecting the doped iron phosphate according to claim 3 to a first calcination, adding a lithium source and a carbon source, and mixing, subjecting a resulting mixture to spray granulation and a second calcination to obtain the carbon-coated manganese-doped lithium iron phosphate.

19. A preparation method for carbon-coated manganese-doped lithium iron phosphate, comprising the following steps:
subjecting the doped iron phosphate according to claim 4 to a first calcination, adding a lithium source and a carbon source, and mixing, subjecting a resulting mixture to spray granulation and a second calcination to obtain the carbon-coated manganese-doped lithium iron phosphate.

20. Use of the doped iron phosphate according to claim 2 in the preparation of a lithium battery cathode material.
